(19) United States
(12) Patent Application Publication
(10) Pub. No.: US 2024/0119282 A1
(43) Pub. Date: Apr. 11, 2024

(54) METHOD AND APPARATUS FOR SEARCHING FOR LIGHT-WEIGHT MODEL THROUGH REPLACEMENT OF SUBNETWORK OF TRAINED NEURAL NETWORK MODEL

(71) Applicant: Electronics and Telecommunications Research Institute, Daejeon (KR)

(72) Inventors: Jongryul LEE, Daejeon (KR); Yong Hyuk Moon, Daejeon (KR); Junyong Park, Daejeon (KR)

(73) Assignee: Electronics and Telecommunications Research Institute, Daejeon (KR)

(21) Appl. No.: 18/356,415

(22) Filed: Jul. 21, 2023

(30) Foreign Application Priority Data
Oct. 7, 2022 (KR) 10-2022-0128649

(51) Int. Cl. G06N 3/08

(52) U.S. Cl. CPC G06N 3/08

(57) ABSTRACT

The present disclosure relates to a method and apparatus for searching for a light-weight model through the replacement of a subnetwork of a trained neural network model. The method of searching for a light-weight model includes a preprocessing step of extracting a subnetwork from an original neural network model, constructing a mapping relation between the subnetwork and an alternative block corresponding to the subnetwork by extracting the alternative block from a pre-trained neural network model, and generating profiling information including performance information relating to the subnetwork and the alternative block, and a query processing step of receiving a query, extracting a constraint that is included in the query through query parsing, and generating the final model based on the constraint, the original neural network model, the alternative block, the mapping relation, and the profiling information.

### CROSS-REFERENCE TO RELATED APPLICATION

This application claims priority to and the benefit of Korean Patent Application No. 10-2022-0128649, filed on Oct. 7, 2022, the disclosure of which is incorporated herein by reference in its entirety.

### BACKGROUND

### 1. Technical Field

The present disclosure relates to an artificial intelligence and/or machine learning method and apparatus and, particularly, to a method and apparatus for searching for a light-weight model, which coincides with the light weighting of a neural network model and a query.

### 2. Related Art

As the deep learning technology is generalized, neural network models that have been optimized for various light-weight devices become increasingly common. If a neural network model optimized for each target device and environment is separately searched for, search and learning costs are very much increased. Accordingly, there have been suggested various methods for reducing the costs. However, the existing methods still require high GPU costs because the existing methods never use weights of other models that have already been trained or adopt a method of indirectly using such weights like knowledge distillation in searching for a light-weight model. That is, the existing methods have limitations in that high GPU operation costs are still required to generate a model for satisfying various constraints.

In order to increase the popularization and value of the artificial intelligence (AI) technology, there is a need for a method of dynamically searching for a light-weight model which has been optimized for a resource (e.g., a CPU/GPU share or an available memory size) of an edge device at a low GPU cost.

### SUMMARY

Various embodiments are directed to a method and apparatus for searching for a light-weight model, which has been optimized for each target device/runtime environment at a low cost through the replacement of a subnetwork of various neural network models that have already been trained, including an original neural network model.

Furthermore, various embodiments are directed to a method and apparatus for searching for a light-weight model, which may be used in an arbitrary task and environment to which a neural network model may be applied without being dependent on a specific task or environment.

Objects of the present disclosure are not limited to the aforementioned object, and other objects not described above may be evidently understood by those skilled in the art from the following description.

In an embodiment, a method of searching for a light-weight model through the replacement of a subnetwork of a trained neural network model includes a preprocessing step of extracting a subnetwork from an original neural network model, constructing a mapping relation between the subnetwork and an alternative block corresponding to the subnetwork by extracting the alternative block from a pre-trained neural network model, and generating profiling information including performance information relating to the subnetwork and the alternative block, and a query processing step of receiving a query, extracting a constraint that is included in the query through query parsing, and generating the final model based on the constraint, the original neural network model, the alternative block, the mapping relation, and the profiling information.

In an embodiment, the preprocessing step includes steps of extracting the subnetwork from the original neural network model, constructing the mapping relation between the subnetwork and the alternative block by extracting the alternative block corresponding to the subnetwork from the pre-trained neural network model, and generating the profiling information based on the subnetwork and the alternative block. In this case, the subnetwork is one connected neural network.

In an embodiment, the query processing step may include steps of receiving the query and extracting the constraint through query parsing, generating a candidate neural network model based on the original neural network model, the alternative block, and the mapping relation, and evaluating the candidate neural network model based on the constraint and the profiling information and selecting the final model from the candidate neural network model based on results of the evaluation of the candidate neural network model.

In an embodiment, the step of constructing the mapping relation between the subnetwork and the alternative block may include determining compatibility between the subnetwork and the alternative block and constructing the mapping relation based on the compatibility. In this case, the compatibility means that each of the input and output of the subnetwork and each of the input and output of the alternative block have an identical number of dimensions and an identical number of channels and a change in a spatial dimension of data when the data passes through the subnetwork and a change in a spatial dimension of the data when the data passes through the alternative block are identical with each other.

In an embodiment, the step of constructing the mapping relation between the subnetwork and the alternative block may include determining the compatibility between the subnetwork and the alternative block, and adjusting the number of channels of the alternative block by using at least any one of schemes including pruning and the addition of a projection layer, if the compatibility is not satisfied because at least any one of the number of input channels and the number of output channels of the alternative block is different from at least any one of the number of input channels and the number of output channels of the subnetwork.

In an embodiment, the preprocessing step may include after constructing the mapping relation, training the alternative block by using a knowledge distillation scheme based on data for training the alternative block, the original neural network model, and the mapping relation, and generating the profiling information including performance information relating to the subnetwork and the trained alternative block.

In an embodiment, the profiling information may include at least any one of accuracy of the original neural network model before and after replacement of the subnetwork with the alternative block, inference time and memory usage of the subnetwork and the alternative block, or any combination of the inference time, the memory usage and the accuracy.

In an embodiment, the constraint may include at least any one of a target platform, target latency, and target memory usage or a combination of the target platform, the target latency, and the target memory usage.

In an embodiment, the query processing step may include training the final model by using a knowledge distillation scheme based on data for training the final model and the original neural network model, and outputting the trained final model.

Furthermore, in an embodiment, an apparatus for searching for a light-weight model includes a preprocessing module configured to extract a subnetwork from an original neural network model, construct a mapping relation between the subnetwork and an alternative block corresponding to the subnetwork by extracting the alternative block from a pre-trained neural network model, and generate profiling information including performance information relating to the subnetwork and the alternative block, and a query processing module configured to receive a query, extract a constraint that is included in the query through query parsing, and generate the final model based on the constraint, the original neural network model, the alternative block, the mapping relation, and the profiling information.

In an embodiment, the preprocessing module may include a subnetwork generation unit configured to extract the subnetwork from the original neural network model, an alternative block generation unit configured to construct the mapping relation between the subnetwork and the alternative block by extracting the alternative block corresponding to the subnetwork from the pre-trained neural network model, and a profiling unit configured to generate the profiling information based on the subnetwork and the alternative block. In this case, the subnetwork is one connected neural network.

In an embodiment, the query processing module may include a query parsing unit configured to receive the query and extract the constraint through query parsing, a candidate model generation unit configured to generate a candidate neural network model based on the original neural network model, the alternative block, and the mapping relation, and a candidate model evaluation unit configured to evaluate the candidate neural network model based on the constraint and the profiling information and to select the final model from the candidate neural network model based on results of the evaluation of the candidate neural network model.

In an embodiment, the alternative block generation unit may determine compatibility between the subnetwork and the alternative block, and may construct the mapping relation based on the compatibility. In this case, the compatibility may mean that each of the input and output of the subnetwork and each of the input and output of the alternative block have an identical number of dimensions and an identical number of channels and a change in a spatial dimension of data when the data passes through the subnetwork and a change in a spatial dimension of the data when the data passes through the alternative block are identical with each other.

In an embodiment, the alternative block generation unit may determine the compatibility between the subnetwork and the alternative block, and may adjust the number of channels of the alternative block by using at least any one of schemes including pruning and the addition of a projection layer, if the compatibility is not satisfied because at least any one of the number of input channels and the number of output channels of the alternative block is different from at least any one of the number of input channels and the number of output channels of the subnetwork.

In an embodiment, after constructing the mapping relation, the preprocessing module may train the alternative block by using a knowledge distillation scheme based on data for training the alternative block, the original neural network model, and the mapping relation, and may generate the profiling information including performance information relating to the subnetwork and the trained alternative block.

In an embodiment, the profiling information may include at least any one of, accuracy of the original neural network model before and after replacement of the subnetwork with the alternative block, inference time and memory usage of the subnetwork and the alternative block, or any combination of the inference time, the memory usage and the accuracy.

In an embodiment, the constraint may include at least any one of a target platform, target latency, and target memory usage or a combination of the target platform, the target latency, and the target memory usage.

In an embodiment, the query processing module may train the final model by using a knowledge distillation scheme based on data for training the final model and the original neural network model, and may output the trained final model.

In an embodiment, the alternative block generation unit may construct the mapping relation by extracting, from the pre-trained neural network model, the alternative block having the compatibility, but having a structure different from a structure of the subnetwork. In this case, the different structure means that at least any one of criteria including a parameter, the number of layers, an arrangement of the layers, a connection structure between the layers, or a conversion function or a combination of the criteria is different.

The present disclosure relates to the method and apparatus for searching for a light-weight model, which derive the final model by replacing a subnetwork which is obtained from various neural network models that have already been trained, and may expect the following effects.

(1) In the existing search methods, in order to define a search space, various parameters, such as which layer or block will be used, have to be defined and searched for. In the present disclosure, however, the existing trained models are used. That is, in the present disclosure, a cost for defining a search space is almost 0 because a module block whose effects have already been verified in the existing other search is included in the search space and used. In short, according to the present disclosure, the unnecessary definition of a search space can be reduced.

(2) In the present disclosure, in constructing the final output model, a re-training process and an alternative block training process through knowledge distillation can be performed more rapidly because not a weight that is randomly initialized, but a weight that has been calculated in other training is used. Accordingly, according to the present disclosure, a model suitable for a constraint can be output more quickly compared to the existing technology because a query processing time can be greatly reduced.

(3) In the existing model delay time prediction method, the delay time of all models is predicted based on an actual delay time that has been measured on the basis of a layer level. However, if layers are complexly connected, the existing prediction method has a problem in that the accuracy of prediction may be reduced. The present disclosure has an effect in that the delay time of all models can be predicted simply and accurately compared to the existing prediction method because the delay time is predicted based on a block level not a layer.

Effects of the present disclosure which may be obtained in the present disclosure are not limited to the aforementioned effects, and other effects not described above may be evidently understood by a person having ordinary knowledge in the art to which the present disclosure pertains from the following description.

### BRIEF DESCRIPTION OF THE DRAWINGS

FIG. 1 is an exemplary diagram of a model search method including a preprocessing step and a query processing step.

FIG. 2 is a diagram specifically illustrating the preprocessing step of FIG. 1, and is an exemplary diagram of a method of searching for a replaceable subnetwork of an original neural network model and generating and training an alternative block.

FIG. 3 is an exemplary diagram of a process of extracting a replaceable subnetwork within an original neural network model.

FIG. 4 is an exemplary diagram of a method of generating a domain set (B) of alternative blocks in FIG. 2.

FIG. 5 is an exemplary diagram of a method of generating an alternative block which may be used instead of a replaceable subnetwork of the original neural network model in FIG. 2.

FIG. 6 is an exemplary diagram of a method of training an alternative block through knowledge distillation.

FIG. 7 is a diagram specifically illustrating the query processing step of FIG. 1, and is an exemplary diagram of a method of searching for an optimal model when a query is given after an alternative block information set that has been trained and an original neural network model are previously loaded.

FIG. 8 is an exemplary diagram of a method of generating a candidate output model through the replacement of a subnetwork based on alternative blocks that have been selected from alternative block information and that may be used together.

FIG. 9 is an exemplary diagram of the materialization of the process of replacing a subnetwork in FIG. 8, and is an exemplary diagram of a method of generating a candidate output model by replacing, with compatible alternative blocks, blocks which may be replaced in an original model.

FIG. 10 is an exemplary diagram of a method of additionally training (or fine-tuning) an output model that has been finally generated, through the knowledge distillation of an original model.

FIGS. 11 to 13 are flowcharts for describing a method of searching for a light-weight model through the replacement of a subnetwork of a trained neural network model according to an embodiment of the present disclosure.

FIG. 14 is a block diagram illustrating a construction of an apparatus for searching for a light-weight model according to an embodiment of the present disclosure.

FIG. 15 is a block diagram illustrating a computer system for implementing the method according to an embodiment of the present disclosure.

### DETAILED DESCRIPTION

The present disclosure relates to a method and apparatus for searching for a light-weight model, which coincides with the light weighting of a neural network model and a query. Specifically, the present disclosure relates to a method and apparatus for constructing a light-weight model which may be calculated even in a device having limited resources, such as an edge device, through the replacement of a subnetwork of a neural network model that has already been trained.

Advantages and characteristics of the present disclosure and a method for achieving the advantages and characteristics will become apparent from the embodiments described in detail later in conjunction with the accompanying drawings. However, the present disclosure is not limited to the disclosed embodiments, but may be implemented in various different forms. The embodiments are merely provided to complete the present disclosure and to fully notify a person having ordinary knowledge in the art to which the present disclosure pertains of the category of the present disclosure. The present disclosure is merely defined by the category of the claims. Terms used in this specification are used to describe embodiments and are not intended to limit the present disclosure. In this specification, an expression of the singular number also includes an expression of the plural number unless clearly defined otherwise in the context. The term “comprises” and/or “comprising” used in this specification does not exclude the presence or addition of one or more other components, steps, operations and/or elements in addition to mentioned components, steps, operations and/or elements.

In describing the present disclosure, a detailed description of a related known technology will be omitted if it is deemed to make the subject matter of the present disclosure unnecessarily vague.

Hereinafter, embodiments of the present disclosure are described in detail with reference to the accompanying drawings. In describing the present disclosure, in order to facilitate general understanding of the present disclosure, the same reference numeral is used for the same mean regardless of the reference numeral.

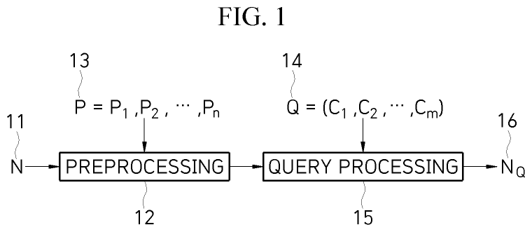

FIG. 1 is an exemplary diagram of a light-weight model search method including a preprocessing step and a query processing step. The search method includes the preprocessing step of using, as an input, an original neural network model (N) that has been input and a set (P) of models that have already been trained and the query processing step of processing a query that includes a description of a target environment and a constraint.

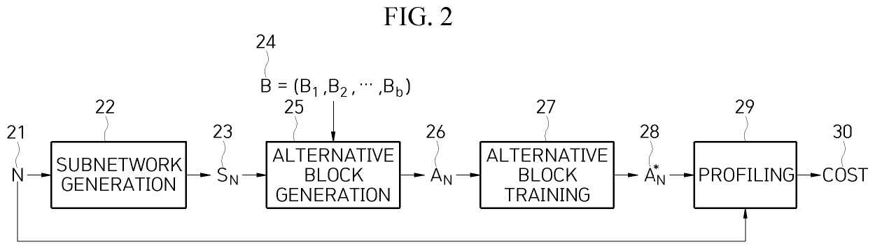

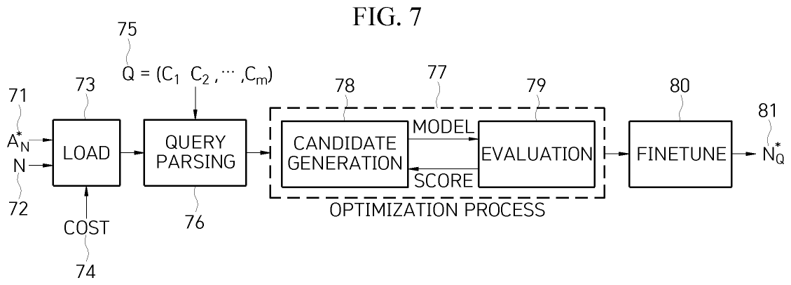

An apparatus 400 for searching for a light-weight model according to an embodiment of the present disclosure performs a preprocessing step 12 by using the original neural network model (N) 11 and the set (P) 13 of models that have already been trained. The preprocessing step 12 is described in detail later with reference to FIG. 2. Thereafter, when a query 14 including a constraint on a target platform is given, the apparatus 400 for searching for a light-weight model according to an embodiment of the present disclosure performs a query processing step 15 of outputting the final result model (N_{Q}) 16 by searching for an optimal model for the query 14 based on information obtained in the preprocessing step 12. The query processing step 15 is described in detail later with reference to FIG. 7. Any constraint on models that are used in the present disclosure and that have already been trained is not present, and any arbitrary model may be included in the models.

FIG. 2 is a diagram specifically illustrating the preprocessing step 12 of FIG. 1, and is an exemplary diagram of a method of searching for a replaceable subnetwork of the original neural network model (N) and generating and training an alternative block.

First, the apparatus 400 for searching for a light-weight model according to an embodiment of the present disclosure performs a process 22 of receiving an original neural network model (N) 21 and generating a set (S_{N}) 23 of replaceable subnetworks from the original neural network model (N). The “replaceable subnetwork (replaceable subnetwork block)” is a subnetwork of the original neural network model and also means one connected network (e.g., a neural network) that has not been separated. Next, the apparatus 400 for searching for a light-weight model according to an embodiment of the present disclosure performs a process 25 of generating an alternative block by sampling subnetworks compatible with replaceable blocks of the set (S_{N}) from a set (B) 24 of candidate blocks. An i-th element of an alternative block information set (A_{N}) 26 that is obtained in this process is represented as (Oᵢ and Aᵢ) for convenience sake. Oᵢ is a replaceable block of the original neural network model (N) and belongs to the set (S_{N}). Aᵢ is one of the set (B) 24 of candidate blocks, which are compatible with the replaceable block (O). The alternative block information set (A_{N}) 26 may be constructed to include an actual block (e.g., an alternative block (Bₖ) compatible with a replaceable block (Sᵢ)) that is mapped to the replaceable block (Sᵢ), along with mapping information between the replaceable block (Sᵢ) and the compatible alternative block (Bₖ). One subnetwork that belongs to the set (S_{N}) may appear as an element of the alternative block information set (A_{N}) several times. That is, with respect to arbitrary different elements (Oᵢ and Aᵢ) and (Oⱼ and Aⱼ) of the alternative block information set (A_{N}), the element (Oᵢ and Oⱼ) may be the same subnetwork. Each alternative block (Aᵢ) of the alternative block information set (A_{N}) is trained through a training process 27 based on knowledge distillation by using the element Oi that has been mapped therewith. The alternative block information set that has experienced such a process is represented as a trained alternative block information set (A*_{N}) 28. Finally, the apparatus 400 for searching for a light-weight model according to an embodiment of the present disclosure measures accuracy and the amount of accuracy change of the original neural network model (N) before and after replacement when each replaceable subnetwork block of the original neural network model are replaced with each trained alternative block, inference time and memory usage of each replaceable subnetwork block and each compatible alternative block, through a profiling process 29 based on the trained alternative block information set (A*_{N}) and the original neural network model (N). The apparatus 400 for searching for a light-weight model according to an embodiment of the present disclosure stores results calculated in the profiling process 29 in a cost 30, that is, profiling information. The cost 30 (profiling information) may include the inference time, the memory usage of each of the subnetwork and the alternative block, and the accuracy and the amount of accuracy change of the original neural network model(N) before and after replacement with each trained alternative block. The cost 30 is subsequently used when a query is input.

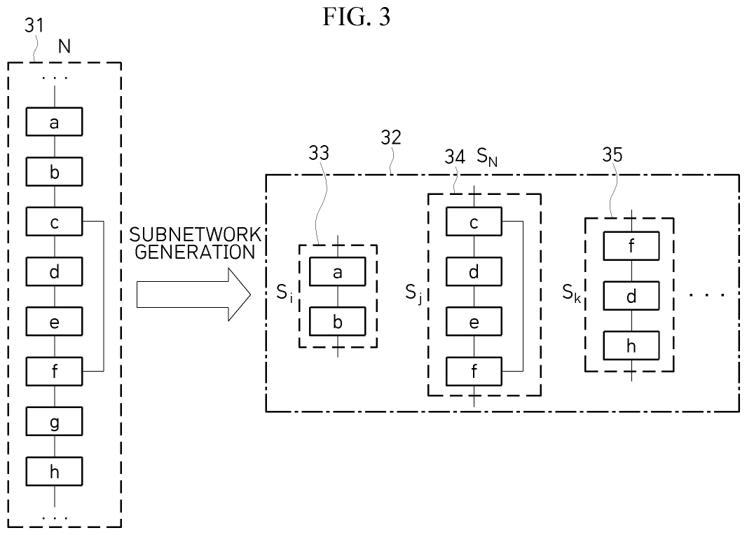

FIG. 3 is an exemplary diagram of a process of extracting a replaceable subnetwork within the original neural network model (N). That is, FIG. 3 is the materialization of the process 22 of generating a subnetwork in FIG. 2.

The apparatus 400 for searching for a light-weight model according to an embodiment of the present disclosure may construct a random subnetwork in a way to designate a random start location in an original neural network model (N) 31, search for a graph structure of the model at the start location from an input direction to an output direction (i.e., transversely), but randomly terminate the search. In FIG. 3, “a” to “h” mean layers. When the apparatus 400 for searching for a light-weight model according to an embodiment of the present disclosure constructs the random subnetwork, a subnetwork block may have one input or two or more inputs. Furthermore, the subnetwork block may have one output or two or more outputs. Sᵢ 33, Sⱼ 34, and Sₖ 35 are examples of random subnetworks generated as described above, and are included in a set (S_{N}) 32 of replaceable subnetworks. The present disclosure does not set a limit on a subnetwork search method. Accordingly, another method other than the method illustrated in FIG. 3 may be applied for subnetwork search.

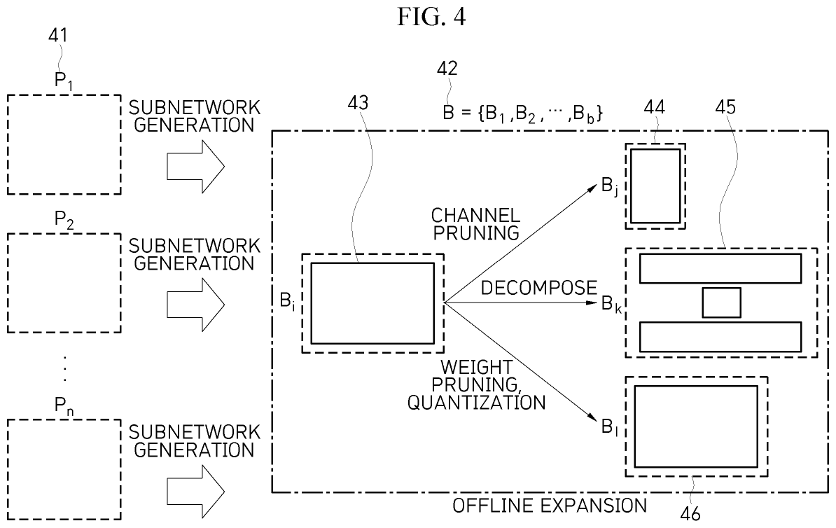

FIG. 4 is an exemplary diagram of a method of generating the domain set (B) 24 of alternative blocks in FIG. 2.

P₁ to Pₙ 41 are pre-trained neural network models. The original neural network model (N) may also be included in the trained neural network models from a viewpoint of the light weighting of a neural network model.

The apparatus 400 for searching for a light-weight model according to an embodiment of the present disclosure may extract a subnetwork for each model from the pre-trained neural network models 41 by using the same method as the method of searching for a subnetwork, which has been described with reference to FIG. 3. A subnetwork (Bi) 43 that has been extracted from the pre-trained neural network models 41 is subsequently used as an alternative block. The subnetwork Bi experiences an offline expansion process of generating alternative blocks which may be additionally used by applying several neural network model light weighting schemes (e.g., channel pruning, decomposition, weight pruning, and quantization) as various scales again. Bⱼ 44, Bₖ 45, and Bₗ 46 are examples of alternative blocks that are generated through the offline expansion process. All of subnetworks (i.e., alternative blocks) obtained as described above are constructed as one domain set (B) 42, and is used in the process 25 of generating an alternative block in FIG. 2.

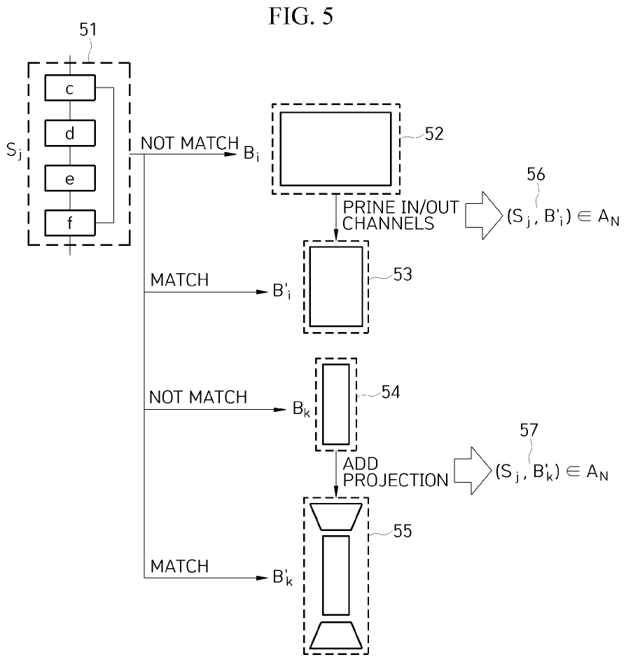

FIG. 5 is an exemplary diagram of the process 25 of generating an alternative block which may be used instead of a replaceable subnetwork of the original neural network model (N) in FIG. 2. FIG. 5 is the materialization of a process of correcting input and output channel values in the process 25 of generating an alternative block compatible with a subnetwork of the original neural network model (N) in FIG. 2.

The apparatus 400 for searching for a light-weight model according to an embodiment of the present disclosure may use all pairs of the set (S_{N}) of replaceable subnetworks and blocks that belong to the domain set (B) of alternative blocks generated above in the process of generating an alternative block, may check compatibility between two blocks (i.e., the subnetwork (Sⱼ) and the alternative block (Bₖ)) by randomly sampling each of the subnetwork (Sⱼ) and the alternative block Bₖ, and may then add the two blocks (i.e., the subnetwork (Sⱼ) and the alternative block (Bₖ)) to the alternative block information set (A_{N}) if the two blocks are compatible with each other. Furthermore, the apparatus 400 for searching for a light-weight model may add, to the alternative block information set (A_{N}), the alternative block (Bₖ) having a structure (e.g., a parameter, the number of layers, the arrangement of the layers, a connection structure between the layers, or a conversion function), which is compatible with the structure of the subnetwork (Sⱼ) of the original neural network model (N), but is different from that of the subnetwork (Sⱼ) of the original neural network model (N), by mapping the alternative block (Bₖ) to the subnetwork (Sⱼ). In this case, if any alternative block (Bₖ) is compatible with an arbitrary subnetwork (Sᵢ) 51 of the original neural network model (N), this may mean that the input and output (i.e., an input tensor and an output tensor) of the subnetwork (Sⱼ) and the input and output (i.e., an input tensor and an output tensor) of the alternative block Bₖ, which have the same number of dimensions and the same number of channels, may correspond to each other and a change in the spatial dimension of data when the data passes through the two blocks (i.e., the alternative block and the subnetwork) is the same. If a constraint on which the number of channels (i.e., a channel size) of an input and output needs to be the same, among constraints on which the alternative block (Bₖ) is compatible with the subnetwork (Sⱼ) 51, is not satisfied, the alternative block (Bᵢ, Bₖ) may be made to be compatible with the subnetwork (Sⱼ) of the original neural network model (N) by using a method of pruning (52 and 53) the channels of the alternative block or adding (54 and 55) a projection layer. If the projection layer is added, an initial weight of the projection layer is set as a random value and is then calculated through learning. In FIG. 5, an alternative block (B′ᵢ) 53 is the results of the adjustment of the alternative block through the channel pruning. An alternative block (B′ₖ) 55 is the results of the adjustment of an unmatched channel by adding a projection layer before and after the input and output of the alternative block. The latter case is used when the input or output channel of the alternative block (B′ₖ) is smaller than the input or output channel of the subnetwork (Sⱼ). If the input channel of the alternative block (B′ₖ) is great, but the output channel thereof is small compared to the subnetwork (Sⱼ), the apparatus 400 for searching for a light-weight model according to an embodiment of the present disclosure may generate a compatible alternative block by complexly applying channel pruning and the addition of a projection layer. A pair (56 and 57) of the subnetwork and the compatible alternative block becomes an element of the alternative block information set (A_{N}).

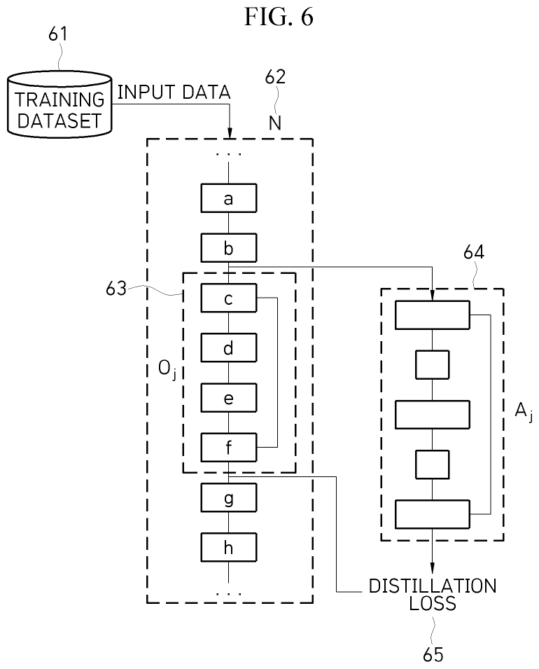

FIG. 6 is an exemplary diagram of a method of training an alternative block through knowledge distillation. FIG. 6 is the materialization of a method 27 of training an alternative block that has been searched for in FIG. 2 through knowledge distillation.

The apparatus 400 for searching for a light-weight model according to an embodiment of the present disclosure processes a portion (Aⱼ) 64 of an alternative block information set, which corresponds to the input of a subnetwork (Oⱼ) 63 of an original neural network model (N) 62, based on input data that is obtained from training data 61, calculates a loss function 65 (or a distillation loss) by comparing the outputs of the two blocks (i.e., the subnetwork Oⱼ and the alternative block Aⱼ), and trains the alternative block information set (Aⱼ) 64 in a way (knowledge distillation) to minimize a knowledge distillation loss function value (a knowledge distillation loss, a distillation loss). In this case, the knowledge distillation loss based on the outputs of the two subnetworks (Oⱼ and Aⱼ) may be calculated by using various loss functions, such as Kullback-Leibler divergence and a mean squared error. The present disclosure does not set a limit on the loss function that is used to calculate the knowledge distillation loss.

FIG. 7 is a diagram specifically illustrating the query processing step 15 of FIG. 1, and is an exemplary diagram of a method of searching for an optimal model when a query is given after the trained alternative block information set (A*_{N}) and the original neural network model (N) are previously loaded.

First, the apparatus 400 for searching for a light-weight model according to an embodiment of the present disclosure loads (73) a trained alternative block information set (A*_{N}) 71, an original neural network model (N) 72, and profiling information (Cost) 74. When receiving a query (Q), the apparatus 400 for searching for a light-weight model extracts a constraint included in the query (Q) through query parsing. For example, the query (Q) may include a constraint on a target platform, target latency, or target memory usage. For reference, the constraint on the target platform may be related to a device or runtime environment in which a model operates. The constraint on the target latency refers to a latency target value for the inference of the final model. When receiving the query (Q) 75 including the constraint on a target platform, target latency, and target memory usage, the apparatus 400 for searching for a light-weight model parses (76) the query, and performs a process 77 of searching for an optimal model that satisfies the constraint included in the query (Q). The process 77 of searching for an optimal model is a common optimization process, and includes a process 78 of generating a candidate model and a process 79 of evaluating the candidate model. The apparatus 400 for searching for a light-weight model according to an embodiment of the present disclosure generates candidate output neural network models through the process 78 of generating the candidate model. The apparatus 400 for searching for a light-weight model according to an embodiment of the present disclosure evaluates the candidate output neural network models based on the query (Q) through the process 79 of evaluating the candidate model. The apparatus 400 for searching for a light-weight model may evaluate the candidate output neural network models based on the constraint included in the query (Q) and the profiling information. The apparatus 400 for searching for a light-weight model according to an embodiment of the present disclosure performs an additional training (or fine-tuning) process 80 on a model (N_{Q}) that has been calculated to have the highest evaluation score, and outputs the final model (N*_{Q}) 81 for which additional training (or fine-tuning) has been completed.

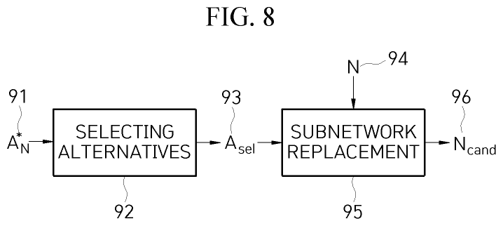

FIG. 8 is an exemplary diagram of a process of generating a candidate output model through the replacement of a subnetwork based on a compatible alternative block, and is the materialization of the process 78 of generating a candidate model in FIG. 7.

First, the apparatus 400 for searching for a light-weight model according to an embodiment of the present disclosure selects (92) a partial set (Aₛₑₗ) 93 of alternative blocks from a trained alternative block information set (A*_{N}) 91. In this case, a method of extracting an element of the partial set (Aₛₑₗ) is not limited to any method, and may include a random sampling method. However, a subnetwork Oᵢ that is included in arbitrary elements (Oᵢ and Aᵢ) belonging to the partial set (Aₛₑₗ) does not have a layer that overlaps a subnetwork of another element belonging to the partial set (Aₛₑₗ) in the original neural network model (N). The apparatus 400 for searching for a light-weight model according to an embodiment of the present disclosure uses the partial set (Aₛₑₗ) 93 that has been generated as described above in a process 95 of replacing a subnetwork, and performs a re-routing task on all the elements (Oᵢ and Aᵢ) of the partial set (Aₛₑₗ) so that the element Aᵢ is used instead of the element Oᵢ in the original neural network model (N) 94 through the process 95. Since the inputs and outputs of the two blocks (i.e., the alternative block (Aᵢ) and the subnetwork (Oᵢ)) are mapped in a one-to-one manner, the apparatus 400 for searching for a light-weight model according to an embodiment of the present disclosure may perform the re-routing task based on a corresponding relation between the inputs and outputs of the two blocks Oᵢ and Aᵢ. The apparatus 400 for searching for a light-weight model according to an embodiment of the present disclosure generates a candidate neural network model (N_{cand}) 96 through the process 95 of replacing a subnetwork.

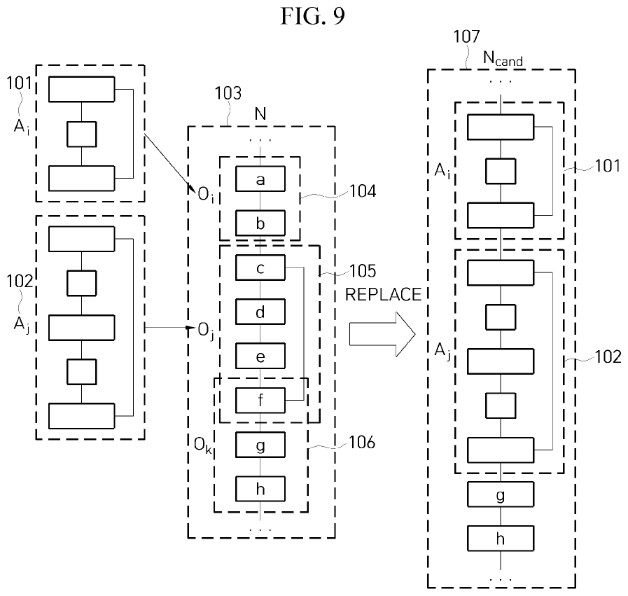

FIG. 9 is an exemplary diagram of the materialization of the process 95 of replacing a subnetwork in FIG. 8, and is an exemplary diagram of a process of generating a candidate output model by replacing, with compatible alternative blocks, blocks which may be replaced in an original model.

In FIG. 9, Aᵢ 101, Aⱼ 102, Oᵢ 104, and Oⱼ 105 mean the blocks of (Oᵢ and Aᵢ) and (Oⱼ and Aⱼ) belonging to the partial set (Aₛₑₗ). In the original neural network model (N), the block (Aᵢ) 101 is used instead of the block (O) 104, and the block (Aⱼ) 102 is used instead of the block (Oⱼ) (105). In FIG. 9, Oₖ (106) is another subnetwork that belongs to the trained alternative block information set (A*_{N}), but does not belong to the partial set (Aₛₑₗ) because Oₖ (106) overlaps the block (Oⱼ) 105 in an f layer of an original neural network model (N) 103. The apparatus 400 for searching for a light-weight model according to an embodiment of the present disclosure generates a candidate neural network model (N_{cand}) 107 as its output by performing a subnetwork replacement task on all the elements of the partial set (Aₛₑₗ).

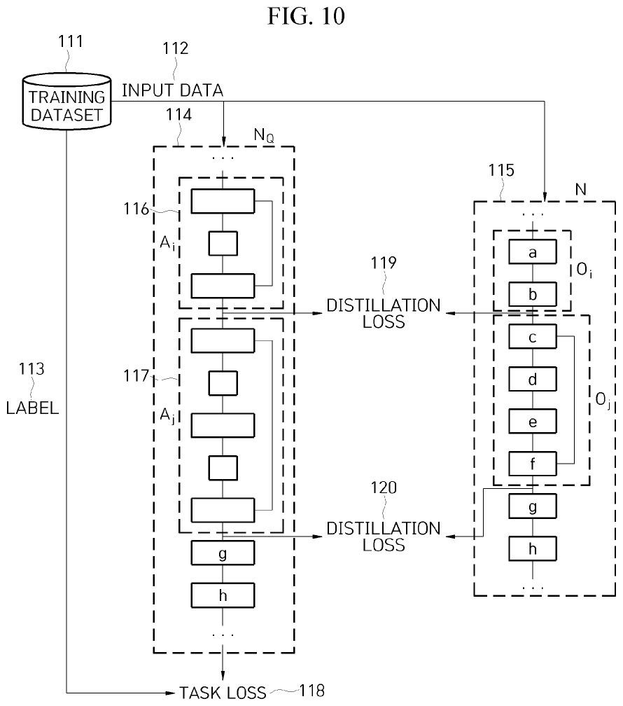

FIG. 10 is an exemplary diagram of a process of additionally training (or fine-tuning) an output model that has been finally generated, through the knowledge distillation of an original model. FIG. 10 is the materialization of the additional training process 80 in FIG. 7.

The apparatus 400 for searching for a light-weight model according to an embodiment of the present disclosure generates the final output model (N*_{Q}) that has been additionally trained by additionally training (or fine-tuning) the final output model (N_{Q}) 114 by using a knowledge distillation scheme based on an original neural network model (N) 115.

An additional training (or fine-tuning) process 80 illustrated in FIG. 10 is a fine-tuning (or retraining) process for the final output model (N_{Q}) 114. In this process, more stable training is attempted through knowledge distillation. The apparatus 400 for searching for a light-weight model according to an embodiment of the present disclosure performs a task for comparing a teacher and a student (i.e., calculates a knowledge distillation loss) for knowledge distillation, with respect to elements of the partial set (Aₛₑₗ) that is used to generate the final output model (N_{Q}) based on input data 112 that has been extracted from a training data set 111. For example, in FIG. 10, losses for knowledge distillation (i.e., distillation losses 119 and 120) are defined between Oᵢ and Aᵢ 116 and Oⱼ and Aⱼ 117 because (Oᵢ and Aᵢ) and (Oⱼ and Aⱼ) have been used to generate the final output model (N_{Q}). As in FIG. 6, the type of loss function is not limited.

The apparatus 400 for searching for a light-weight model according to an embodiment of the present disclosure may calculate a task loss 118 of the final output model (N_{Q}) 114 based on a label 113 that has been extracted from the training data set 111, and may train the final output model (N_{Q}) 114 based on the task loss 118.

The apparatus 400 for searching for a light-weight model according to an embodiment of the present disclosure may train the final output model (N_{Q}) 114 based on the knowledge distillation losses 119 and 120 and the task loss 118.

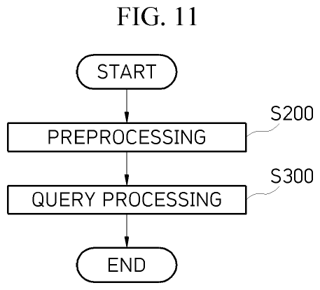

FIGS. 11 to 13 are flowcharts for describing a method of searching for a light-weight model through the replacement of a subnetwork of a trained neural network model according to an embodiment of the present disclosure.

The method of searching for a light-weight model through the replacement of a subnetwork of a trained neural network model according to an embodiment of the present disclosure includes steps S200 and S300.

Step S200 is a preprocessing step. The apparatus 400 for searching for a light-weight model according to an embodiment of the present disclosure generates a set (S_{N}) of replaceable blocks (subnetworks) of an original neural network model (N), a set (A*_{N}) of a pair of trained alternative blocks which may replace subnetworks, and profiling information (Cost) that is performance information relating to a replaceable block and a trained alternative block, based on the original neural network model (N) and a pre-trained neural network model P. Detailed contents of step S200 have been described above with reference to FIG. 2.

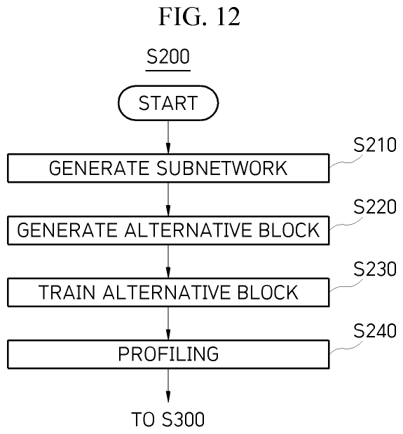

Step S200 is described in detail below with reference to FIG. 12. Step S200 includes steps S210 to S240.

Step S210 is a subnetwork generation step. The apparatus 400 for searching for a light-weight model generates the set (S_{N}) of replaceable subnetworks by extracting replaceable subnetworks of the original neural network model (N) based on the original neural network model (N). The apparatus 400 for searching for a light-weight model may extract the replaceable subnetwork by using a random sampling scheme. However, the present disclosure does not set a limit on a subnetwork search method. Detailed contents of step S210 have been described above with reference to FIG. 3.

Step S220 is an alternative block generation step. The apparatus 400 for searching for a light-weight model generates an alternative block information set (A_{N}), based on the set (S_{N}) of replaceable subnetworks and a domain set (B) of alternative blocks. Specifically, the apparatus 400 for searching for a light-weight model generates the domain set (B) of alternative blocks based on the pre-trained neural network model P. In this process, the apparatus 400 for searching for a light-weight model may use a neural network model light weighting scheme. Furthermore, the apparatus 400 for searching for a light-weight model generates a set (i.e., an alternative block information set) (A_{N}) of a pair of a replaceable subnetwork and an alternative block. In this case, the apparatus 400 for searching for a light-weight model may add, to the alternative block information set (A_{N}), an alternative block (Bₖ) having a structure (e.g., a parameter, the number of layers, the arrangement of the layers, a connection structure between the layers, or a conversion function), which is compatible with the structure of a subnetwork (Sᵢ) of the original neural network model (N), but is different from that of the subnetwork (Sᵢ) of the original neural network model (N), by mapping the alternative block (Bₖ) to the subnetwork (Sᵢ). As described above, the apparatus 400 for searching for a light-weight model may change the number of input and output channels of the alternative block (Bₖ) by using a scheme, such as pruning or the addition of a projection layer, in order to match the number of input and output channels of the subnetwork (Sⱼ) of the original neural network model (N) and the number of input and output channels of the alternative block (Bₖ). Detailed contents of step S220 have been described above with reference to FIGS. 4 and 5.

Step S230 is an alternative block training step. The apparatus 400 for searching for a light-weight model generates a trained alternative block information set (A*_{N}) by using a knowledge distillation scheme based on the original neural network model (N) and the alternative block information set (A_{N}). That is, the apparatus 400 for searching for a light-weight model generates the trained alternative block information set (A*_{N}), including a pair of the subnetwork (Sᵢ) of the original neural network model (N) and a trained compatible alternative block, by training the alternative block (Bₖ) by using the knowledge distillation scheme. A loss function that is used in step S230 is not limited. Various loss functions, such as Kullback-Leibler divergence and a mean square error, may be used as the loss function. Detailed contents of step S230 have been described above with reference to FIG. 6.

Step S240 is a profiling step. The apparatus 400 for searching for a light-weight model generates profiling information (Cost), that is, performance information relating to a replaceable block of the original neural network model (N) and the trained compatible alternative block through profiling based on the trained alternative block information set (A*_{N}) and the original neural network model (N). For example, the apparatus 400 for searching for a light-weight model generates the profiling information (Cost) by measuring inference time, memory usage of each replaceable subnetwork block and each trained alternative block, and by measuring accuracy and the amount of accuracy change of the original neural network model(N) before and after replacement when each replaceable subnetwork block of the original neural network model are replaced with each trained alternative block. The profiling information(Cost) may include the inference time, the memory usage of each of the subnetworks and the trained alternative blocks, and the accuracy and the amount of accuracy change of the original neural network model(N) before and after replacement with each trained alternative block.

Step S300 is a query processing step. First, the apparatus 400 for searching for a light-weight model loads (73) the trained alternative block information set (A*_{N}), the original neural network model (N), and the profiling information (Cost). The apparatus 400 for searching for a light-weight model receives a query (Q) and extracts a constraint included in the query (Q), through query parsing. The apparatus 400 for searching for a light-weight model searches for an optimal model that satisfies the constraint included in the query (Q). That is, the apparatus 400 for searching for a light-weight model generates the final model (N*_{Q}) that most coincides with the constraint included in the query (Q), based on the constraint included in the query (Q), the original neural network model (N), the trained alternative block information set (A*_{N}), and the profiling information (Cost). Detailed contents of step S300 have been described above with reference to FIG. 7.

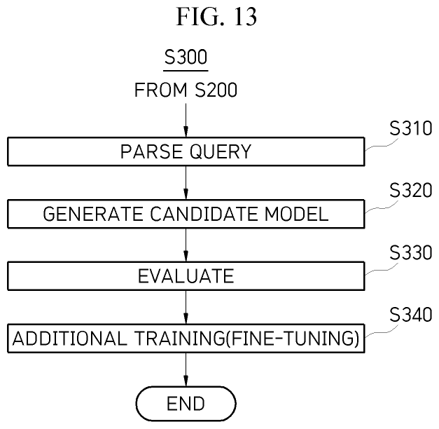

Step S300 is described in detail below with reference to FIG. 13. Step S300 includes steps S310 to S340.

Step S310 is a query parsing step. When receiving the query (Q), the apparatus 400 for searching for a light-weight model extracts the constraint included in the query (Q) through query parsing. For example, the query (Q) may include the constraint on a target platform, target latency, or target memory usage. For reference, the constraint on the target platform may be related to a device or runtime environment in which a model operates. The constraint on the target latency refers to a latency target value for the inference of the final model.

Step S320 is a candidate model generation step. In this step, the apparatus 400 for searching for a light-weight model generates a candidate neural network model (N_{cand}) based on the original neural network model (N) and the trained alternative block information set (A*_{N}). This step may be sub-divided into a step of extracting a partial set (Aₛₑₗ) of alternative blocks from the trained alternative block information set (A*_{N}) and a step of generating the candidate neural network model (N_{cand}) by replacing a subnetwork (O) of the original neural network model (N) with an alternative block (Aᵢ) included in the partial set (Aₛₑₗ). In the process of generating one candidate neural network model (N_{cand}), the layers of a replacement target subnetwork of the original neural network model (N) should not be overlapped. The apparatus 400 for searching for a light-weight model performs a re-routing task on all the elements (Oᵢ and Aᵢ) of the partial set (Aₛₑₗ) so that the element Aᵢ is used instead of the element Oᵢ in the original neural network model (N). Detailed contents of step S320 have been described above with reference to FIGS. 8 and 9.

Step S330 is an evaluation step. The apparatus 400 for searching for a light-weight model evaluates the candidate neural network model (N_{cand}) based on the constraint included in the query (Q), and selects a model having the highest evaluation score as the final model (N_{Q}). The apparatus 400 for searching for a light-weight model may evaluate a candidate output neural network model, based on the constraint included in the query (Q) and the profiling information.

Steps S320 and S330 may be collectively named an optimal model search step. The optimal model search step is a common optimization process.

Step S340 is an additional training (or fine-tuning) step. The apparatus 400 for searching for a light-weight model generates the trained final model (N*_{Q}) by additionally training (or fine-tuning) the final model (N_{Q}) by using a knowledge distillation scheme based on the training data set 111. As in step S230, the type of loss function for calculating a knowledge distillation loss or a task loss is not limited. Detailed contents of step S340 have been described above with reference to FIG. 10.

The aforementioned method of searching for a light-weight model through the replacement of a subnetwork of a trained neural network model has been described with reference to the flowcharts presented in the drawings. For a simple description, the method has been illustrated and described as a series of blocks, but the present disclosure is not limited to the sequence of the blocks, and some blocks may be performed in a sequence different from that of or simultaneously with that of other blocks, which has been illustrated and described in this specification. Various other branches, flow paths, and sequences of blocks which achieve the same or similar results may be implemented. Furthermore, all the blocks illustrated in order to implement the method described in this specification may not be required.

In the description given with reference to FIGS. 11 to 13, each step may be further divided into additional steps or may be combined into smaller steps depending on an implementation example of the present disclosure. Furthermore, some steps may be omitted, if necessary, and the sequence of steps may be changed. Furthermore, although other contents are omitted, the contents described with reference to FIGS. 1 to 10 may be applied to the contents described with reference to FIGS. 11 to 13. Furthermore, the contents described with reference to FIGS. 11 to 13 may be applied to the contents described with reference to FIGS. 1 to 10.

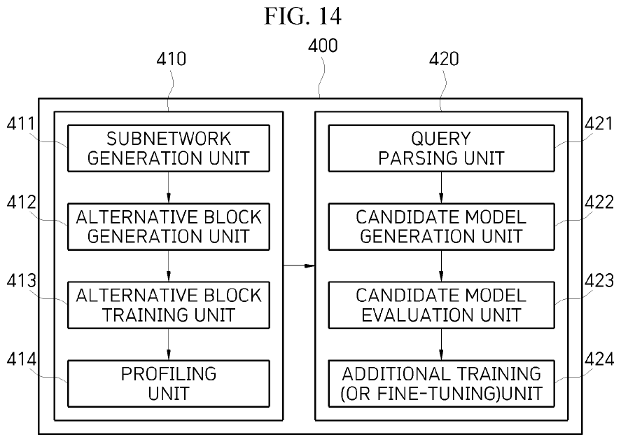

FIG. 14 is a block diagram illustrating a construction of an apparatus for searching for a light-weight model according to an embodiment of the present disclosure.

The apparatus 400 for searching for a light-weight model according to an embodiment of the present disclosure includes a preprocessing module 410 and a query processing module 420. Components of the apparatus 400 for searching for a light-weight model according to the present disclosure are not limited to the embodiment illustrated in FIG. 14.

The preprocessing module 410 includes a subnetwork generation unit 411, an alternative block generation unit 412, an alternative block training unit 413, and a profiling unit 414. Components of the preprocessing module 410 that is included in the apparatus 400 for searching for a light-weight model according to the present disclosure are not limited to the embodiment illustrated in FIG. 14. Some components may be added to the components of the preprocessing module 410, or some of the components of the preprocessing module 410 may be changed or deleted, if necessary.

The subnetwork generation unit 411 generates a set (S_{N}) of replaceable subnetworks by extracting the replaceable subnetwork of an original neural network model (N) based on the original neural network model (N). The subnetwork generation unit 411 may extract the replaceable subnetwork by using a random sampling scheme. However, the present disclosure does not set a limit on the method of searching for subnetworks by the subnetwork generation unit 411. Detailed contents of the operation of the subnetwork generation unit 411 may be understood with reference to FIG. 3 and the description of FIG. 3.

The alternative block generation unit 412 generates an alternative block information set (A_{N}) based on the set (S_{N}) of replaceable subnetworks and a domain set (B) of alternative blocks. Specifically, the alternative block generation unit 412 generates the domain set (B) of alternative blocks based on a pre-trained neural network model P. In this process, the alternative block generation unit 412 may use a neural network model light weighting scheme. Furthermore, the alternative block generation unit 412 generates a set (an alternative block information set (A_{N})) of a pair of a replaceable subnetwork and an alternative block. In this case, the alternative block generation unit 412 may add, to the alternative block information set (A_{N}), an alternative block (Bₖ) having a structure (e.g., a parameter, the number of layers, the arrangement of the layers, a connection structure between the layers, or the conversion function), which is compatible with the structure of a subnetwork (Sᵢ) of the original neural network model (N), but is different from that of the subnetwork (Sᵢ) of the original neural network model (N), by mapping the alternative block (Bₖ) to the subnetwork (Sᵢ). The alternative block generation unit 412 may change the number of input and output channels of the alternative block (Bₖ) by using a scheme, such as pruning or the addition of a projection layer, in order to match the number of input and output channels of the subnetwork (Sᵢ) of the original neural network model (N) and the number of input and output channels of the alternative block (Bₖ). Detailed contents of the operation of the alternative block generation unit 412 may be understood with reference to FIG. 4 and the description of FIG. 4 and FIG. 5 and the description of FIG. 5.

The alternative block training unit 413 generates a trained alternative block information set (A*_{N}) by using a knowledge distillation scheme based on the original neural network model (N) and the alternative block information set (A_{N}). That is, the alternative block training unit 413 generates the trained alternative block information set (A*_{N}), including a pair of the subnetwork (Sᵢ) of the original neural network model (N) and a trained compatible alternative block, by training the alternative block (Bₖ) by using the knowledge distillation scheme. A loss function that is used by the alternative block training unit 413 is not limited. Various loss functions, such as Kullback-Leibler divergence and a mean square error, may be used as the loss function. Detailed contents of the operation of the alternative block training unit 413 may be understood with reference to FIG. 6 and the description of FIG. 6.

The profiling unit 414 generates profiling information (Cost), that is, performance information relating to a replaceable block of the original neural network model (N) and the trained compatible alternative block, through profiling based on the trained alternative block information set (A*N) and the original neural network model (N). For example, the profiling unit 414 generates the profiling information (Cost) by measuring inference time, memory usage of each replaceable subnetwork block and each trained alternative block, and by measuring accuracy and the amount of accuracy change of the original neural network model(N) before and after replacement when each replaceable subnetwork block of the original neural network model are replaced with each trained alternative block. The profiling information(Cost) may include the inference time, the memory usage of each of the subnetworks and the trained alternative blocks, and the accuracy and the amount of accuracy change of the original neural network model(N) before and after replacement with each trained alternative block.

The query processing module 420 includes a query parsing unit 421, a candidate model generation unit 422, a candidate model evaluation unit 423, and an additional training (or fine-tuning) unit 424. Components of the query processing module 420 that is included in the apparatus 400 for searching for a light-weight model according to the present disclosure are not limited to the embodiment illustrated FIG. 14. Some components may be added to the components of the query processing module 420, or some of the components of the query processing module 420 may be changed or deleted, if necessary.

When receiving a query (Q), the query parsing unit 421 extracts a constraint included in the query (Q) through query parsing. For example, the query (Q) may include the constraint on a target platform, target latency, or target memory usage. For reference, the constraint on the target platform may be related to a device or runtime environment in which a model operates. The constraint on the target latency refers to a latency target value for the inference of the final model.

The candidate model generation unit 422 generates a candidate neural network model (N_{cand}) based on the original neural network model (N) and the trained alternative block information set (A*_{N}). An operation of the candidate model generation unit 422 may be divided into an operation of extracting a partial set (Aₛₑₗ) of alternative blocks from the trained alternative block information set (A*_{N}) and an operation of generating the candidate neural network model (N_{cand}) by replacing a subnetwork (Oᵢ) of the original neural network model (N) with an alternative block (Aᵢ) included in the partial set (Aₛₑₗ). In the process of generating, by the candidate model generation unit 422, one candidate neural network model (N_{cand}), the layers of a replacement target subnetwork of the original neural network model (N) should not be overlapped. The candidate model generation unit 422 performs a re-routing task on all the elements (Oᵢ and Aᵢ) of the partial set (Aₛₑₗ) so that the element (Aᵢ) is used instead of the element (Oᵢ) in the original neural network model (N). Detailed contents of the operation of the candidate model generation unit 422 may be understood with reference to FIG. 8 and the description of FIG. 8 and FIG. 9 and the description of FIG. 9.

The candidate model evaluation unit 423 evaluate the candidate neural network model (N_{cand}) based on the constraint included in the query (Q), and selects a model having the highest evaluation score as the final model (N_{Q}). The candidate model evaluation unit 423 may evaluate the candidate neural network model (N_{cand}) based on the constraint included in the query (Q) and the profiling information.

The additional training unit 424 generates a trained final model (N*_{Q}) by additionally training (or fine-tuning) the final model (N_{Q}) by using a knowledge distillation scheme based on the training data set 111. As in the alternative block training unit 413, the type of loss function that is used for the additional training unit 424 to calculate a knowledge distillation loss or a task loss is not limited. Detailed contents of the additional training unit 424 may be understood with reference to FIG. 10 and the description of FIG. 10.

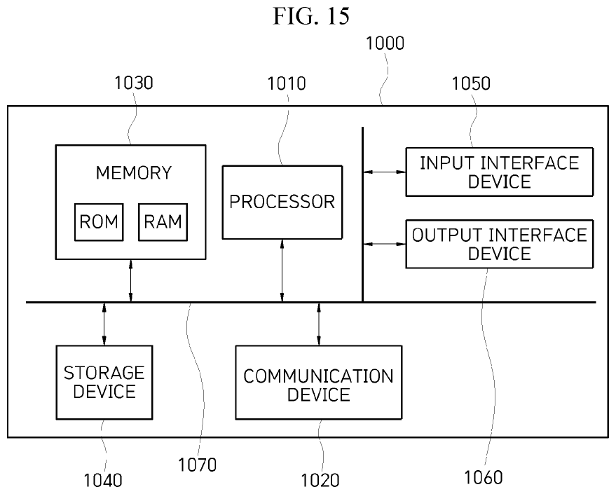

FIG. 15 is a block diagram illustrating a computer system for implementing the method according to an embodiment of the present disclosure.

Referring to FIG. 15, a computer system 1000 may include at least one of a processor 1010, memory 1030, an input interface device 1050, an output interface device 1060, and a storage device 1040 which communicate with one another through a bus 1070. The computer system 1000 may further include a communication device 1020 connected to a network. The processor 1010 may be a central processing unit (CPU) or may be a semiconductor device that executes an instruction stored in the memory 1030 or the storage device 1040. The memory 1030 and the storage device 1040 may include various types of volatile or nonvolatile storage media. For example, the memory may include read only memory (ROM) and random access memory (RAM). In an embodiment of this writing, the memory may be disposed inside or outside the processor, and the memory may be connected to the processor through various means that has already been known. The memory includes various types of volatile or nonvolatile storage media. For example, the memory may include ROM or RAM.

Accordingly, an embodiment of the present disclosure may be implemented as a method implemented in a computer or may be implemented as a non-transitory computer-readable medium in which a computer-executable instruction has been stored. In an embodiment, when being executed by a processor, a computer-readable instruction may perform a method according to at least one aspect of this writing.

The communication device 1020 may transmit or receive a wired signal or a wireless signal.

Furthermore, the method according to an embodiment of the present disclosure may be implemented in the form of a program instruction which may be executed through various computer means, and may be recorded on a computer-readable medium.

The computer-readable medium may include a program instruction, a data file, and a data structure alone or in combination. A program instruction recorded on the computer-readable medium may be specially designed and constructed for an embodiment of the present disclosure or may be known and available to those skilled in the computer software field. The computer-readable medium may include a hardware device configured to store and execute the program instruction. For example, the computer-readable medium may include magnetic media such as a hard disk, a floppy disk, and a magnetic tape, optical media such as CD-ROM and a DVD, magneto-optical media such as a floptical disk, ROM, RAM, and flash memory. The program instruction may include not only a machine code produced by a compiler, but a high-level language code capable of being executed by a computer through an interpreter.

The contents described with reference to FIGS. 1 to 13 may be applied to the contents described with reference to FIGS. 14 and 15. Furthermore, the contents described with reference to FIGS. 14 and 15 may be applied to the contents described with reference to FIGS. 1 to 13.

For reference, the components according to an embodiment of the present disclosure may be implemented in the form of software or hardware, such as a digital signal processor (DSP), a field programmable gate array (FPGA) or an application-specific integrated circuit (ASIC), and may perform predetermined roles.

However, the “components” are not components having meanings limited to software or hardware, and each component may be configured to reside on an addressable storage medium and may be configured to operate one or more processors.

Accordingly, for example, the component may include components, such as software components, object-oriented software components, class components, and task components, processes, functions, attributes, procedures, sub-routines, segments of a program code, drivers, firmware, a microcode, circuitry, data, a database, data structures, tables, arrays, and variables.

Components and functions provided in corresponding components may be combined into fewer components or may be further separated into additional components.

It will be understood that each block of the flowcharts and combinations of the blocks in the flowcharts may be executed by computer program instructions. These computer program instructions may be mounted on the processor of a general purpose computer, a special purpose computer, or other programmable data processing equipment, so that the instructions executed by the processor of the computer or other programmable data processing equipment create means for executing the functions specified in the flowchart block(s). The computer program instructions may also be loaded on a computer or other programmable data processing equipment to cause a series of operational steps to be performed on the computer or other programmable data processing equipment to produce a computer-executed process, so that the instructions executing the computer or other programmable data processing equipment provide steps for executing the functions described in the flowchart block(s).

Furthermore, each block of the flowcharts may represent a portion of a module, a segment, or code, which includes one or more executable instructions for executing a specified logical function(s). It should also be noted that in some alternative implementations, the functions noted in the blocks may occur out of order. For example, two blocks shown in succession may in fact be executed substantially concurrently, or the blocks may sometimes be executed in the reverse order, depending upon the functionality involved.

The term “ . . . unit” or “ . . . module” used in the present embodiment means a software component or a hardware component, such as an FPGA or an ASIC, and the “ . . . unit” or “ . . . module” performs specific tasks. However, the term “ . . . unit” or “ . . . module” does not mean that it is limited to software or hardware. The “ . . . unit” or “ . . . module” may be configured to reside on an addressable storage medium and configured to operate one or more processors. Accordingly, examples of the “ . . . unit” or “ . . . module” may include components, such as software components, object-oriented software components, class components, and task components, processes, functions, attributes, procedures, sub-routines, segments of a program code, drivers, firmware, a microcode, circuitry, data, a database, data structures, tables, arrays, and variables. The functionalities provided in the components and the “ . . . units” or “ . . . modules” may be combined into fewer components and “ . . . units” or “ . . . modules”, or may be further separated into additional components and “ . . . units” or “ . . . modules”. Furthermore, the components and the “ . . . units” or “ . . . modules” may be implemented to operate one or more CPUs within a device or a security multimedia card.

The constructions of the present disclosure have been described in detail above with reference to the accompanying drawings, but are merely illustrative. A person having ordinary knowledge in the art to which the present disclosure pertains will understand that various modifications and changes are possible without departing from the technical spirit of the present disclosure. Accordingly, the scope of the present disclosure is defined by the appended claims rather than by the detailed description, and all changes or modifications derived from the scope of the claims and equivalents thereto should be interpreted as being included in the technical scope of the present disclosure.

### DESCRIPTION OF REFERENCE NUMERALS

400: apparatus for searching for light-weight model
410: preprocessing module
411: subnetwork generation unit
412: alternative block generation unit
413: alternative block training unit
414: profiling unit
420: query processing module
421: query parsing unit
422: candidate model generation unit
423: candidate model evaluation unit
424: additional training (or fine-tuning) unit
1000: computer system
1010: processor
1020: communication device
1030: memory
1040: storage device
1050: input interface device
1060: output interface device
1070: bus

What is claimed is:

1. A method of searching for a light-weight model through the replacement of a subnetwork of a trained neural network model, the method comprising:
a preprocessing step of extracting a subnetwork from an original neural network model, constructing a mapping relation between the subnetwork and an alternative block corresponding to the subnetwork by extracting the alternative block from a pre-trained neural network model, and generating profiling information comprising performance information relating to the subnetwork and the alternative block; and
a query processing step of receiving a query, extracting a constraint that is included in the query through query parsing, and generating a final model based on the constraint, the original neural network model, the alternative block, the mapping relation, and the profiling information.

2. The method of claim 1, wherein the preprocessing step comprises steps of:
extracting the subnetwork from the original neural network model;
constructing the mapping relation between the subnetwork and the alternative block by extracting the alternative block corresponding to the subnetwork from the pre-trained neural network model; and
generating the profiling information based on the subnetwork and the alternative block,
wherein the subnetwork is one connected neural network.

3. The method of claim 1, wherein the query processing step comprises steps of:
receiving the query and extracting the constraint through query parsing;
generating a candidate neural network model based on the original neural network model, the alternative block, and the mapping relation; and
evaluating the candidate neural network model based on the constraint and the profiling information and selecting the final model from the candidate neural network model based on results of the evaluation of the candidate neural network model.

4. The method of claim 2, wherein:
the step of constructing the mapping relation between the subnetwork and the alternative block comprises determining compatibility between the subnetwork and the alternative block and constructing the mapping relation based on the compatibility, and
the compatibility means that each of an input and output of the subnetwork and each of an input and output of the alternative block have an identical number of dimensions and an identical number of channels and a change in a spatial dimension of data when the data passes through the subnetwork and a change in a spatial dimension of the data when the data passes through the alternative block are identical with each other.

5. The method of claim 4, wherein the step of constructing the mapping relation between the subnetwork and the alternative block comprises:
determining the compatibility between the subnetwork and the alternative block, and
adjusting the number of channels of the alternative block by using at least any one of schemes comprising pruning and an addition of a projection layer, if the compatibility is not satisfied because at least any one of the number of input channels and the number of output channels of the alternative block is different from at least any one of the number of input channels and the number of output channels of the subnetwork.

6. The method of claim 1, wherein the preprocessing step comprises:
after constructing the mapping relation, training the alternative block by using a knowledge distillation scheme based on data for training the alternative block, the original neural network model, and the mapping relation, and
generating the profiling information comprising performance information relating to the subnetwork and the trained alternative block.

7. The method of claim 1, wherein the profiling information comprises, at least any one of, accuracy of the original neural network model before and after replacement of the subnetwork with the alternative block, inference time and memory usage of the subnetwork and the alternative block, or any combination of the inference time, the memory usage and the accuracy.

8. The method of claim 1, wherein the constraint comprises at least any one of a target platform, target latency, and target memory usage or a combination of the target platform, the target latency, and the target memory usage.

9. The method of claim 1, wherein the query processing step comprises:
training the final model by using a knowledge distillation scheme based on data for training the final model and the original neural network model, and
outputting the trained final model.

10. An apparatus for searching for a light-weight model, comprising:
a preprocessing module configured to extract a subnetwork from an original neural network model, construct a mapping relation between the subnetwork and an alternative block corresponding to the subnetwork by extracting the alternative block from a pre-trained neural network model, and generate profiling information comprising performance information relating to the subnetwork and the alternative block; and
a query processing module configured to receive a query, extract a constraint that is included in the query through query parsing, and generate a final model based on the constraint, the original neural network model, the alternative block, the mapping relation, and the profiling information.

11. The apparatus of claim 10, wherein the preprocessing module comprises:
a subnetwork generation unit configured to extract the subnetwork from the original neural network model;
an alternative block generation unit configured to construct the mapping relation between the subnetwork and the alternative block by extracting the alternative block corresponding to the subnetwork from the pre-trained neural network model; and
a profiling unit configured to generate the profiling information based on the subnetwork and the alternative block,
wherein the subnetwork is one connected neural network.

12. The apparatus of claim 10, wherein the query processing module comprises:
a query parsing unit configured to receive the query and extract the constraint through query parsing;
a candidate model generation unit configured to generate a candidate neural network model based on the original neural network model, the alternative block, and the mapping relation; and
a candidate model evaluation unit configured to evaluate the candidate neural network model based on the constraint and the profiling information and to select the final model from the candidate neural network model based on results of the evaluation of the candidate neural network model.

13. The apparatus of claim 11, wherein:
the alternative block generation unit determines compatibility between the subnetwork and the alternative block and constructs the mapping relation based on the compatibility, and
the compatibility means that each of an input and output of the subnetwork and each of an input and output of the alternative block have an identical number of dimensions and an identical number of channels and a change in a spatial dimension of data when the data passes through the subnetwork and a change in a spatial dimension of the data when the data passes through the alternative block are identical with each other.

14. The apparatus of claim 13, wherein the alternative block generation unit determines the compatibility between the subnetwork and the alternative block, and adjusts the number of channels of the alternative block by using at least any one of schemes comprising pruning and an addition of a projection layer, if the compatibility is not satisfied because at least any one of the number of input channels and the number of output channels of the alternative block is different from at least any one of the number of input channels and the number of output channels of the subnetwork.

15. The apparatus of claim 10, wherein after constructing the mapping relation, the preprocessing module trains the alternative block by using a knowledge distillation scheme based on data for training the alternative block, the original neural network model, and the mapping relation, and generates the profiling information comprising performance information relating to the subnetwork and the trained alternative block.

16. The apparatus of claim 10, wherein the profiling information comprises at least any one of, accuracy of the original neural network model before and after replacement of the subnetwork with the alternative block, inference time and memory usage of each of the subnetwork and the alternative block, or any combination of the inference time, the memory usage and the accuracy.

17. The apparatus of claim 10, wherein the constraint comprises at least any one of a target platform, target latency, and target memory usage or a combination of the target platform, the target latency, and the target memory usage.

18. The apparatus of claim 10, wherein the query processing module trains the final model by using a knowledge distillation scheme based on data for training the final model and the original neural network model, and outputs the trained final model.

19. The apparatus of claim 13, wherein:
the alternative block generation unit constructs the mapping relation by extracting, from the pre-trained neural network model, the alternative block having the compatibility, but having a structure different from a structure of the subnetwork, and
the different structure means that at least any one of criteria comprising a parameter, a number of layers, an arrangement of the layers, a connection structure between the layers, or a conversion function or a combination of the criteria is different.
